(19) United States
(12) Patent Application Publication
(10) Pub. No.: US 2023/0315990 A1
(43) Pub. Date: Oct. 5, 2023

(54) TEXT DETECTION METHOD AND APPARATUS, ELECTRONIC DEVICE, AND STORAGE MEDIUM

(71) Applicant: Beijing Bytedance Network Technology Co., Ltd., Beijing (CN)

(72) Inventors: Runkai YANG, Beijing (CN); Yuan LIN, Beijing (CN); Hang LI, Beijing (CN)

(21) Appl. No.: 17/926,324

(22) PCT Filed: Jul. 16, 2021
(86) PCT No.: PCT/CN2021/106929

§ 371 Date: Nov. 18, 2022

(30) Foreign Application Priority Data
Jul. 24, 2020 (CN) 202010721748.6

(51) Int. Cl. G06F 40/289

(52) U.S. Cl. CPC G06F 40/289

(57) ABSTRACT

Provided are a text detection method and apparatus, an electronic device and a storage medium. The method includes: determining a first attribute feature of a to-be-detected text and a second attribute feature of elements each having an association relationship with the to-be-detected text; inputting the first attribute feature, the second attribute feature, association relationships between the to-be-detected text and the elements, and association relationships between the elements into a trained network model to obtain a detection result of the to-be-detected text. Such technical solution improves a detection accuracy of a low-quality text.

### CROSS-REFERENCE TO RELATED APPLICATIONS

The present disclosure is a national stage of International Application No. PCT/CN2021/106929, filed on Jul. 16, 2021, which claims the priority of the Chinese Patent Application No. 202010721748.6, filed on Jul. 24, 2020. Both of the aforementioned applications are hereby incorporated by reference in their entireties.

### TECHNICAL FIELD

Embodiments of the present disclosure relate to the field of computer application technologies, and in particular, to a text detection method and apparatus, an electronic device, and a storage medium.

### BACKGROUND

Information-type applications provide an important platform for a large number of users to read, communicate and create. Therefore, it is an important responsibility for such platforms to maintain the quality of texts disseminated on such platforms, which is also an important measure to provide a good environment for the large number of users to read, communicate and create.

A text quality detection method commonly used at present is that, a to-be-detected text is input into a text classification model, and the model outputs a detection result, where the model is obtained through training based on a corpus. Problems with the existing text quality detection method lie in that, on one hand, only the text itself is considered, but a same text may express different meanings in different scenarios, and in this case, the existing text quality detection method cannot make distinctive identification; on the other hand, it is unable for the model to recognize a newly emerging low-quality expression in the text. Therefore, the existing text quality detection method needs to be further improved.

### SUMMARY

Embodiments of the present disclosure provide a text detection method and apparatus, an electronic device, and a storage medium, by which a detection accuracy of a low-quality text is improved.

In a first aspect, an embodiment of the present disclosure provides a text detection method, the method includes:
determining a first attribute feature of a to-be-detected text and a second attribute feature of elements each having an association relationship with the to-be-detected text;
inputting the first attribute feature, the second attribute feature, association relationships between the to-be-detected text and the elements, and association relationships between the elements into a trained network model to obtain a detection result of the to-be-detected text.

In a second aspect, an embodiment of the present disclosure further provides a text detection apparatus, the apparatus includes:
a determining module, configured to determine a first attribute feature of a to-be-detected text and a second attribute feature of elements each having an association relationship with the to-be-detected text;
a detecting module, configured to input the first attribute feature, the second attribute feature, association relationships between the to-be-detected text and the elements, and association relationships between the elements into a trained network model to obtain a detection result of the to-be-detected text.

In a third aspect, an embodiment of the present disclosure further provides a device, the device includes:
one or more processors;
a storage apparatus, configured to store one or more programs,
the one or more programs, when being executed by the one or more processors, cause the one or more processors to implement the text detection method according to any embodiment of the present disclosure.

In a fourth aspect, an embodiment of the present disclosure further provides a storage medium including computer executable instructions. The computer executable instructions, when being executed by a computer processor, cause the text detection method according to any embodiment of the present disclosure to be implemented.

In a fifth aspect, an embodiment of the present disclosure further provides a computer program product, including computer program instructions. The computer executable instructions, when being executed a processor, cause the text detection method according to any embodiment of the present disclosure to be implemented.

In a sixth aspect, an embodiment of the present disclosure further provides a computer program. The computer program, when being executed by a processor, causes the text detection method according to any embodiment of the present disclosure to be implemented.

In the technical solutions of the embodiments of the present disclosure, through technical means of determining a first attribute feature of a to-be-detected text and a second attribute feature of elements each having an association relationship with the to-be-detected text, and inputting the first attribute feature, the second attribute feature, association relationships between the to-be-detected text and the elements, and association relationships between the elements into a trained network model to obtain a detection result of the to-be-detected text, a purpose of improving a detection precision of a low-quality text is realized.

### BRIEF DESCRIPTION OF DRAWINGS

The above-mentioned and other features, advantages and aspects of various embodiments of the present disclosure will become more apparent, in conjunction with the accompanying drawings and with reference to the following specific embodiments. Throughout the accompanying drawings, the same or similar reference numbers refer to the same or similar elements. It should be understood that the accompanying drawings are illustrative, and originals and elements are not necessarily drawn to scale.

FIG. 1 is a schematic flowchart of a text detection method according to Embodiment 1 of the present disclosure.

FIG. 2 is a schematic flowchart of a text detection method according to Embodiment 2 of the present disclosure.

FIG. 3 is a schematic structural diagram illustrating association relationships between nodes according to Embodiment 2 of the present disclosure.

FIG. 4 is a schematic flowchart of another text detection method according to Embodiment 2 of the present disclosure.

FIG. 5 is a schematic flowchart of a text detection method according to Embodiment 3 of the present disclosure.

FIG. 6 is a schematic diagram of obtaining a zero-order feature vector of a node corresponding to a to-be-detected text according to Embodiment 3 of the present disclosure.

FIG. 7 is a schematic diagram illustrating a training process of a network model (taking a GNN model as an example) according to Embodiment 3 of the present disclosure.

FIG. 8 is a schematic structural diagram of a text detection apparatus according to Embodiment 4 of the present disclosure.

FIG. 9 is a schematic structural diagram of an electronic device according to Embodiment 5 of the present disclosure.

### DESCRIPTION OF EMBODIMENTS

Embodiments of the present disclosure will be described in more detail below with reference to the accompanying drawings. Although some embodiments of the present disclosure are shown in the accompanying drawings, it should be understood that the present disclosure may be implemented in various forms and should not be construed as being limited to the embodiments illustrated herein; rather, these embodiments are provided for more thorough and comprehensive understanding of the present disclosure. It should be understood that the drawings and embodiments of the present disclosure are only for the purpose of illustration, and are not intended to limit the protection scope of the present disclosure.

It should be understood that the various steps described in the method embodiments of the present disclosure may be performed in different orders and/or in parallel. In addition, the method embodiments may include additional steps and/or omit the implementation of some shown steps. The scope of the present disclosure is not limited in this regard.

The term “include” and variations thereof used herein are intended for an open-ended inclusion, i.e., “including but not limited to”. The term “based on” used herein means “based at least partly on”. The term “an embodiment” used herein represents “at least one embodiment”; the term “another embodiment” used herein represents “at least one another embodiment”; and the term “some embodiments” used herein represents “at least some embodiments”. Relevant definitions of other terms will be given in the description below.

It should be noted that the concepts such as “first” and “second” mentioned in the present disclosure are merely used to distinguish different apparatuses, modules or units, and are not used to limit the sequence or interdependence of functions performed by these apparatuses, modules or units.

It should be noted that modifications of “a” and “a plurality of” mentioned in the present disclosure are illustrative rather than restrictive, those skilled in the art should understand that they should be understood as “one or more”, unless explicitly indicated in the context otherwise.

### Embodiment 1

FIG. 1 is a schematic flowchart of a text detection method according to Embodiment 1 of the present disclosure. The method can be applied to a scenario of performing a quality detection on a text displayed on an information-type application platform. For example, it is detected whether the displayed text includes sensitive words, where the sensitive words may be specifically uncivilized words, words related to political speech, and the like. If the displayed text includes any of the above-mentioned sensitive words, the displayed text is determined to be a low-quality text, and the platform will screen out such text and prevent it from being displayed to public, so as to create a good platform environment. The method may be performed by a text detection apparatus, which may be implemented in the form of software and/or hardware.

As shown in FIG. 1, the text detection method provided by the embodiment includes steps as follows.

At Step 110, a first attribute feature of a to-be-detected text and a second attribute feature of elements each having an association relationship with the to-be-detected text are determined.

Exemplarily, the first attribute feature may specifically include at least one of: a text feature, a picture feature, a soundtrack feature, a number-of-likes feature, a number-of-forwarding feature, a number-of-comments feature, a comment information feature, a number-of-views feature, and an online time feature, and the like.

The text feature specifically refers to segmented words that compose the to-be-detected text. The picture feature may refer to information on an image or picture emerging in the to-be-detected text. The soundtrack feature may refer to a background music of the to-be-detected text. The number-of-likes feature refers to the number of likes given by other users. Usually, if a user (which may be understood as a reader of the to-be-detected text) is interested in the to-be-detected text after reading it, he/she generally gives a like to the to-be-detected text. The number-of-forwarding feature refers to a feature on the number of times that the to-be-detected text has been forwarded. The number-of-comments feature refers to a feature on the number of times that the to-be-detected text has been commented. The online time feature refers to a time duration during which the to-be-detected text is displayed on the platform.

The element having an association relationship with the to-be-detected text includes at least one of: an author, a reader, and comment information. The corresponding second attribute feature includes at least one of: a reader portrait, an author portrait, and a release time feature. The second attribute feature mainly refers to some inherent features and behavioral features of the element itself. It is intended to determine, through the second attribute feature, a behavioral habit and a behavioral pattern of the corresponding element (such as the reader or the author), as a reference factor for the detection of a low-quality text. As such, it enables a purpose of improving the detection precision of a low-quality text, and it improves the applicability to a newly emerging low-quality text that is popular on the Internet, to enable an accurate detection of such newly emerging low-quality text of a new type, thereby improving the robustness and versatility of the detection model.

Scene information of the to-be-detected text may be more fully expressed through the first attribute feature and the second attribute feature, accordingly, different detection results for the same text in different scenes can be given based on the first attribute feature and the second attribute feature, thereby improving the detection precision of the text. Furthermore, by combining the portrait and behavioral habit of the author who releases the to-be-detected text, as well as the portrait and behavioral habit of the reader of the to-be-detected text, the newly emerging low-quality text of the new type can be accurately identified. This is because, although an expression content and an expression form of the text may be changed, the behavioral habits of the same author and reader cannot be changed. Therefore, a recognition rate of the low-quality text of the new type can be improved, by incorporating the author's portrait and behavioral habit and the reader's portrait and behavioral habit.

For example, the to-be-detected text is “greedy, really want to eat”, if it is in a scene where such text is a comment made for a picture of a delicious food, in this scene, the to-be-detected text is a normal text, not a low-quality text; and if it is in a scene where such text is a comment made for a picture of a very pretty and charming girl, in this scene, the to-be-detected text is a vulgar and low-quality text. In the technical solution of the embodiment, by combining multi-dimensional reference information of the to-be-detected text including author information, reader information, comment information, commented information and the like, the scene information of the to-be-detected text can be fully considered, which enables a more accurate detection result to be given for the to-be-detected text.

At step 120, the first attribute feature, the second attribute feature, association relationships between the to-be-detected text and the elements, and association relationships between the elements, are input into a trained network model to obtain a detection result of the to-be-detected text.

The association relationship between the to-be-detected text and the element may specifically be that: for example, when the element is the reader, the association relationship may be a reading relationship, that is, the reader element reads the to-be-detected text; the association relationship may also be a liking relationship, that is, the reader gives a like to the to-be-detected text; and the association relationship may also be a forwarding relationship, a commenting relationship, and the like. The association relationships between the elements refer to that: for example, two different reader elements read the same to-be-detected text, give a like to the same to-be-detected text, comment on the same to-be-detected text or forward the same to-be-detected text. Based on the association relationships between the elements, it may be determined which readers have common interests and hobbies, and then it is possible to predict, by using online behaviors of a reader who has more online behaviors, similar online behaviors of readers with the same interests and hobbies as this reader, so as to dig more behavioral habits of the readers, to make them serve as reference features for the detection of a low-quality text.

The network model may be any deep learning neural network model, which is not limited in the embodiment. It can be understood that the network model with better performance can be obtained through training, as long as the number of samples is sufficient and the quality of the samples is good. In the technical solution of the embodiment of the present disclosure, the network model plays a role in detecting whether the to-be-detected text is a low-quality text, based on the first attribute feature of the to-be-detected text, the second attribute feature of the elements each having an association relationship with the to-be-detected text, the association relationships between the to-be-detected text and the elements, and the association relationships between the elements. Inputs of the network model are the first attribute feature, the second attribute feature, the association relationships between the to-be-detected text and the elements, and the association relationships between the elements, and the output of the network model is the detection result indicating whether the to-be-detected text is of low quality. For example, if the output result is 1, it means that the to-be-detected text is a low-quality text; and if the output result is 0, it means that the to-be-detected text is not a low-quality text. The first attribute feature, the second attribute feature, the association relationships between the to-be-detected text and the elements, and the association relationships between the elements may be characterized by a specific structure diagram, and this content may specifically refer to the content of subsequent Embodiment 2. The sample data used to train the network model may include: a structure diagram, that is established based on the relationships between individual elements on a content platform and feature attributes of the elements, and that is used to represent an attribute feature of a text element, attribute features of other elements having an association relationship with the text, association relationships between the text and the elements, and association relationships between the elements; and result information indicating that whether the text is a low-quality text.

In the technical solution of the embodiment of the present disclosure, it detects whether a to-be-detected text is a low-quality text, according to a first attribute feature of the to-be-detected text, a second attribute feature of elements each having an association relationship with the to-be-detected text, association relationships between the to-be-detected text and the elements, and association relationships between the elements. It not only considers the features of the to-be-detected text itself, but also makes full use of information of other dimensions related to the to-be-detected text, fully considering context information of the to-be-detected text, and improving a detection precision of a low-quality text. By combining a portrait and behavioral habit of an author who releases the to-be-detected text, as well as a portrait and behavioral habit of a reader of the to-be-detected text, a newly emerging low-quality text of a new type can be accurately identified, and a recognition rate of the low-quality text of the new type is improved. This is because, although an expression content and an expression form of the low-quality text of the new type would be changed, the behavioral habits of the same author and reader are not easily changed in a short period of time, and are relatively stable. Therefore, by incorporating the author's portrait and behavioral habit and the reader's portrait and behavioral habit, the recognition rate of the low-quality text of the new type can be improved.

### Embodiment 2

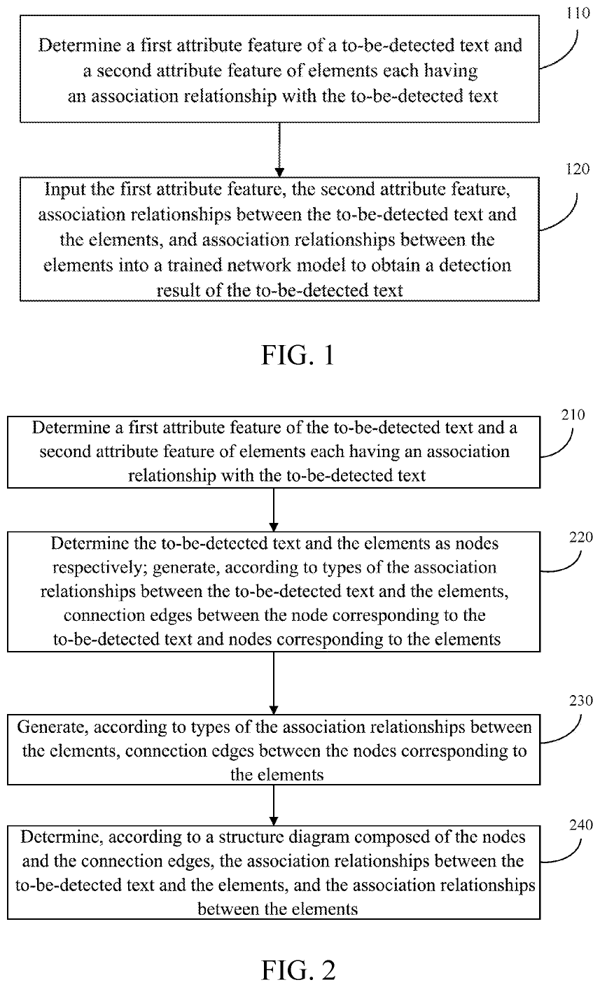

FIG. 2 is a schematic flowchart of a text detection method according to Embodiment 2 of the present disclosure. On the basis of the above embodiment, the solution is further optimized in this embodiment. Specifically, a way of expressing the association relationships between the to-be-detected text and the elements and the association relationships between the elements is provided, so that the network model can efficiently use the association relationships to perform detection and operations on the to-be-detected text, thereby further improving the detection performance of the network model.

As shown in FIG. 2, the method includes steps as follows.

At step 210, a first attribute feature of a to-be-detected text and a second attribute feature of elements each having an association relationship with the to-be-detected text are determined.

At step 220, the to-be-detected text and the elements are determined as nodes respectively; and according to types of the association relationships between the to-be-detected text and the elements, connection edges are generated between a node corresponding to the to-be-detected text and nodes corresponding to the elements.

At step 230, according to types of the association relationships between the elements, connection edges are generated between the nodes corresponding to the elements.

A text display platform generally includes multiple elements, such as an author, an article, a reader, and a comment. Information contained by the individual elements is also heterogeneous, for example, the author's information may include an ID, a gender, and the like; the article's information may include a text, a picture, a soundtrack, and the like; the reader's information may include an ID, a gender, an age, and the like; the comment's information may include a text, a release time, and the like. In addition, the individual elements are also related to each other, for example, the author creates an article, a user reads it, gives a like to it, comments it, and performs other behaviors. Information features of different elements are associated together as a reference feature for the detection of a low-quality text, which can effectively improve the detection precision of the low-quality text.

Exemplarily, the element includes at least one of: the author, the reader and the comment information. The type of the association relationship includes at least one of: a reading relationship, a releasing relationship, a liking relationship, a commenting relationship, and a forwarding relationship. The different elements on a text display platform and the association relationships between the elements may be abstracted into a structure of a diagram, and a corresponding structure diagram is generated according to user logs of the platform.

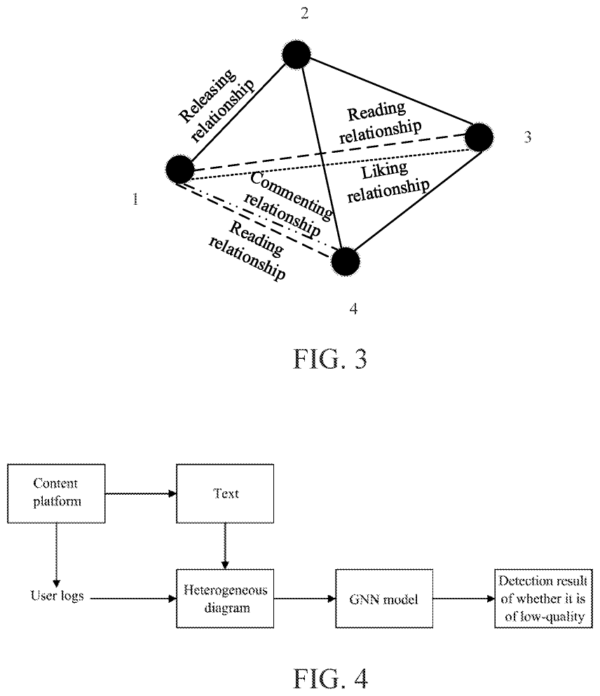

Referring to a schematic structural diagram illustrating association relationships between nodes shown in FIG. 3, it is assumed that the structural diagram includes node 1 (corresponding to the to-be-detected text), node 2 (corresponding to an author of the to-be-detected text), node 3 (corresponding to reader 3) and node 4 (corresponding to reader 4). Since the author releases a text, there is a connection edge of a releasing relationship between node 2 and node 1. It is assumed that reader 3 reads the to-be-detected text, there is a connection edge of a reading relationship between node 1 and node 3; in addition, reader 3 also gives a like to the to-be-detected text, and there is a connection edge of a liking relationship between node 1 and node 3. It is assumed that reader 4 reads and comments on the to-be-detected text, there are a connection edge of the reading relationship and a connection edge of a commenting relationship between node 4 and node 1. Since both reader 3 and reader 4 read the same to-be-detected text, there is a connection edge between node 3 and node 4, indicating that they have read the same text. If reader 4 also gives a like to the to-be-detected text, there would also be a connection edge between node 3 and node 4 indicating that they have given a like to the same text. Since both reader 3 and reader 4 have read the text released by the author corresponding to node 2, there are connection edges respectively between node 3 and node 2 and between node 4 and node 2, indicating that they have read the text released by the author corresponding to node 2.

At step 240, according to a structure diagram composed of the nodes and the connection edges, the association relationships between the to-be-detected text and the elements, and the association relationships are determined between the elements.

Exemplarily, the network model may specifically be a graph neural network (GNN). The GNN is widely used in social networks, knowledge mapping, recommender systems, and even life sciences and other fields, and is powerful in modeling a dependency relationship between nodes of a graph.

Correspondingly, referring to the schematic flowchart of another text detection method shown in FIG. 4, it specifically includes: generating, based on user logs of a text content platform, a heterogeneous diagram of association relationships between elements such as a to-be-detected text, a reader, an author, and comment information, and then inputting the heterogeneous diagram into a trained GNN model to obtain a detection result of whether the to-be-detected text is a low-quality text. The technical solution of the embodiment can distinguish and accurately identify the detection results corresponding to the same text content in different scenarios. It not only considers the to-be-detected text itself, but also makes full use of information of other dimensions related to the to-be-detected text, thereby improving the detection accuracy of a low-quality text and a recall rate of the low-quality text. When detecting the to-be-detected text, the network model extracts features from online behaviors of the author and readers of the to-be-detected text. In a practical scene, when a new low-quality content emerges, since the behavioral habits and behavioral patterns of the author and readers often do not change much, the network model can still accurately identify the new low-quality content, low-quality Internet vocabularies, etc.

In the technical solution of the embodiment of the present disclosure, according to the association relationships between various elements of a text di splay platform, such as behaviors of a reader including reading a text, giving a like to the text, commenting the text, forwarding the text and the like, a structure diagram representing the association relationships between the elements is constructed; and then, the structure diagram and feature information of each element node are input into a network model, to obtain a low-quality text detection result with a high precision, improving the detection precision and efficiency of the low-quality text.

On the basis of the above technical solutions, the structure diagram composed of the nodes and the connection edges would be very large, specifically, the node corresponding to the to-be-detected text may have a lot of neighbor nodes, and the neighbor nodes would have a huge number of neighbor nodes. In consideration of this, in order to reduce a computational load of the network model while retaining key features, a set rule may be used to sample the neighbor nodes of the node corresponding to the to-be-detected text, so as to reduce the number of its neighbor nodes, thereby reducing the computational load of the network model while retaining key features. A sampling rule may indicate random sampling, or it may be a formulated sampling rule, for example, for reader nodes of the to-be-detected text, they may be screened and filtered according to a reading time, for example, only the reader nodes that have read the to-be-detected text in the last 10 days are retained, so as to achieve a purpose of sampling.

Exemplarily, the according to a structure diagram composed of the nodes and the connection edges, the association relationships are determined between the to-be-detected text and the elements, and the association relationships are determined between the elements includes:
performing a sampling operation on neighbor nodes of the node corresponding to the to-be-detected text, to reduce the number of the neighbor nodes of the node corresponding to the to-be-detected text, where the neighbor nodes are nodes each having a connection edge with the node corresponding to the to-be-detected text;
determining a structure diagram composed of the node corresponding to the to-be-detected text, neighbor nodes obtained through sampling, and a node associated with the neighbor nodes obtained through sampling, as the association relationships between the to-be-detected text and the elements and the association relationships between the elements.

### Embodiment 3

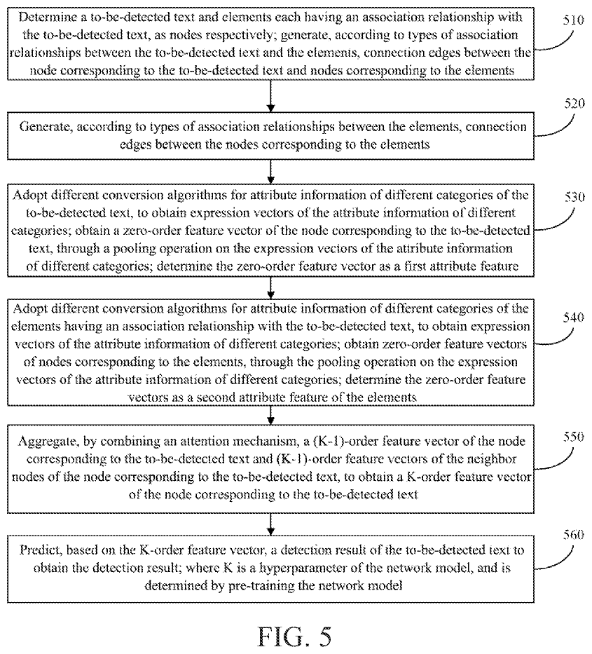

FIG. 5 is a schematic flowchart of a text detection method according to Embodiment 3 of the present disclosure. On the basis of the above embodiments, the solution is further optimized in this embodiment. Specifically, an implementation of determining the above first attribute feature and the second attribute feature is provided, so as to make them conform to input requirements of the network model, while taking into account the feature of each element, without losing an effective feature. As shown in FIG. 5, the method includes steps as follows.

At step 510, a to-be-detected text and elements each having an association relationship with the to-be-detected text are determined as nodes respectively; and according to types of the association relationships between the to-be-detected text and the elements, connection edges are generated between the node corresponding to the to-be-detected text and nodes corresponding to the elements.

At step 520, according to types of the association relationships between the elements, connection edges are generated between the nodes corresponding to the elements.

At step 530, different conversion algorithms are adopted for attribute information of different categories of the to-be-detected text, to obtain expression vectors of the attribute information of different categories; a zero-order feature vector of the node corresponding to the to-be-detected text is obtained, through a pooling operation on expression vectors of the attribute information of different categories; and the zero-order feature vector is determined as the first attribute feature.

At step 540, different conversion algorithms are adopted for attribute information of different categories of the elements having an association relationship with the to-be-detected text, to obtain expression vectors of the attribute information of different categories; zero-order feature vectors of the nodes corresponding to the elements are obtained, through the pooling operation on the expression vectors of the attribute information of different categories; and the zero-order feature vectors are determined as the second attribute feature of the elements.

Exemplarily, the attribute information of different categories of the to-be-detected text includes at least one of: numerical-type attribute information (such as the number of likes given to the to-be-detected text, the number of comments made on the to-be-detected text, and the number of times that the to-be-detected text has been read); text-type attribute information (such as segmented words of the to-be-detected text); image-type attribute information (such as a picture of the to-be-detected text); and audio-type attribute information (such as a soundtrack of the to-be-detected text).

For the text-type attribute information, the conversion algorithm is, for example, word2vec or a bag-of-words model algorithm. For category-type attribute information representing a text category (such as an entertainment-type text, a finance-type text), the conversion algorithm is, for example, a one-hot encoding algorithm. For the image-type attribute information, the conversion algorithm is, for example, a SIFT (Scale Invariant Feature Transform, scale invariant feature transform) algorithm.

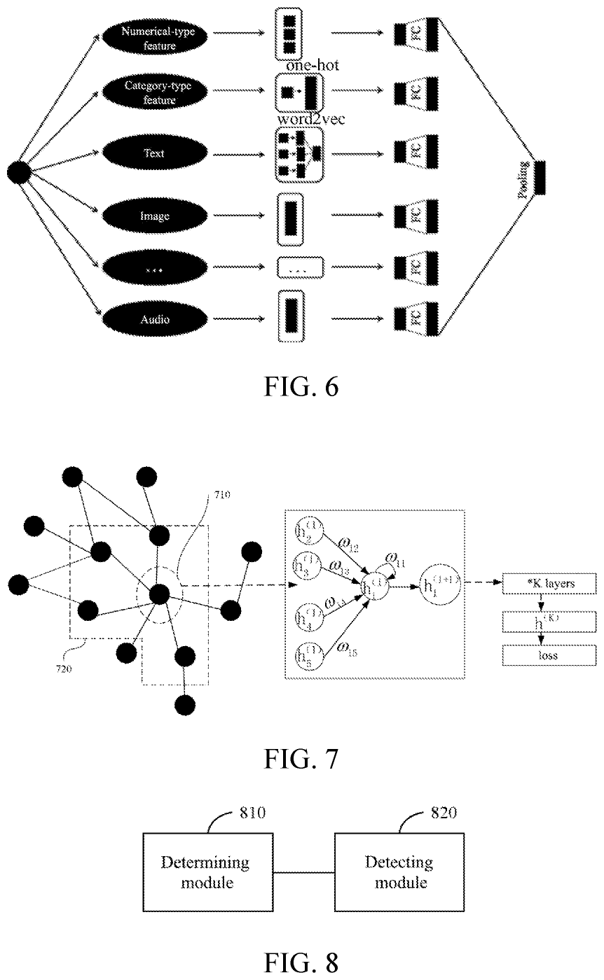

Correspondingly, reference is made to a schematic diagram of obtaining the zero-order feature vector of the node corresponding to the to-be-detected text shown in FIG. 6. Because in the heterogeneous diagram generated by the to-be-detected text, associated elements and their association relationships, the subjects represented by the nodes in the diagram are different, for example, some node represents the to-be-detected text, and some nodes represent the reader(s), author(s), comment information, etc. And the attribute information of different nodes is also different. For example, the attribute information of the node of the to-be-detected text may include the number of views, the number of likes given, the number of times that the text have been forwarded, an online time, and the like. Therefore, it is necessary to design a reasonable and generic manner to generate the zero-order feature vector, which maps all kinds of nodes to a same expression space, so that a unified aggregation operation may be performed on different kinds of nodes. As shown in FIG. 6, the different information contained on various nodes is mapped, through a fully connected layer, to a vector space of a unified dimension, and then effective features are extracted through a pooling operation of a pooling layer, to obtain the zero-order feature vectors of the nodes. In the field of natural language processing, the feature vector of a word is usually called word embedding, that is, embedding.

At step 550, a (K−1)-order feature vector of the node corresponding to the to-be-detected text and (K−1)-order feature vectors of the neighbor nodes of the node corresponding to the to-be-detected text are aggregated by combining an attention mechanism, to obtain a K-order feature vector of the node corresponding to the to-be-detected text.

After obtaining the zero-order feature vectors of the individual nodes, a first-order feature vector of the node corresponding to the to-be-detected text may be obtained based on the zero-order feature vector of the node corresponding to the to-be-detected text and the zero-order feature vectors of its neighbor nodes; a second-order feature vector of the node corresponding to the to-be-detected text may be obtained based on the first-order feature vector of the node corresponding to the to-be-detected text and the first-order feature vectors of its neighbor nodes, and so on, to obtain the K-order feature vector of the node corresponding to the to-be-detected text.

A basic principle of the attention mechanism attention is to selectively screen out a small amount of important information from a large amount of information and focus on an impact of these important information on the output result. By adding the attention mechanism, more effective features of each node may be extracted in the aggregation process, so as to improve an extraction effect of the feature vector.

At step 560, based on the K-order feature vector, the detection result of the to-be-detected text is predicted to obtain the detection result; where K is a hyperparameter of the network model, and is determined by pre-training the network model.

Exemplarily, referring to a schematic diagram of a training process of a network model (taking a GNN model as an example) shown in FIG. 7, first, a heterogeneous diagram generated based on a to-be-detected text and its associated elements is sampled. Specifically, neighbor nodes of node 710 corresponding to the to-be-detected text are sampled. Then, a diagram structure between nodes 720 obtained through sampling is input into the network model. The network model performs aggregation, by combining an attention mechanism, and based on a (K−1)-order feature vector of the node corresponding to the to-be-detected text, and (K−1)-order feature vectors of the neighbor nodes corresponding to the to-be-detected text, to obtain a K-order feature vector of the node corresponding to the to-be-detected text. Based on the K-order feature vector, a detection result of the to-be-detected text is predicted, to obtain the detection result. A loss value is calculated based on the detection result and a sample labeling result, and then the loss value is back propagated to adjust model parameters properly. The heterogeneous diagram is a diagram structure obtained through abstract processing based on different elements on a content platform and relationships between the elements. The elements include, for example, a to-be-detected text, a reader of the to-be-detected text, an author of the to-be-detected text, and comment information of the to-be-detected text. The relationships between the elements are that, for example, the author releases a text, and there is a releasing relationship between the author and the text; the reader reads the text, and there is a reading relationship between the reader and the text. Since the types of the elements in the diagram are different, attribute features of the individual elements are also different, the diagram structure is thus called a heterogeneous diagram.

In the technical solution of the embodiment of the present disclosure, a manner of generating a zero-order feature vector of a node, that is, word embedding embedding, is provided. Specifically, different conversion algorithms are adopted for attribute information of different categories of nodes, to obtain expression vectors of the attribute information of different categories; and the zero-order feature vectors of the nodes are obtained through a pooling operation on the expression vectors of the attribute information of different categories. In detecting the to-be-detected text, the network model aggregates, by combining an attention mechanism, a (K−1)-order feature vector of the node corresponding to the to-be-detected text and (K−1)-order feature vectors of neighbor nodes of the node corresponding to the to-be-detected text, to obtain a K-order embedding of the node corresponding to the to-be-detected text. Based on the K-order embedding of the node corresponding to the to-be-detected text, a prediction is performed to obtain the detection result, which achieves the purpose of improving the detection precision of a low-quality text.

### Embodiment 4

FIG. 8 is a text detection apparatus according to Embodiment 4 of the present disclosure. The apparatus includes: a determining module 810 and a detecting module 820.

The determining module 810 is configured to determine a first attribute feature of a to-be-detected text and a second attribute feature of elements each having an association relationship with the to-be-detected text;
the detecting module 820 is configured to input the first attribute feature, the second attribute feature, association relationships between the to-be-detected text and the elements, and association relationships between the elements into a trained network model to obtain a detection result of the to-be-detected text.

On the basis of the above technical solution, the apparatus further includes: a diagram generating module, configured to, before the first attribute feature, the second attribute feature, the association relationships between the to-be-detected text and the elements, and the association relationships between the elements are input into a trained network model, determine the to-be-detected text and the elements as nodes respectively; generate, according to types of the association relationships between the to-be-detected text and the elements, connection edges between the node corresponding to the to-be-detected text and the nodes corresponding to the elements; and generate, according to types of the association relationships between the elements, connection edges between the nodes corresponding to the elements; and
an association relationship determining module, configured to determine, according to a structure diagram composed of the nodes and the connection edges, the association relationships between the to-be-detected text and the elements and the association relationships between the elements.

On the basis of the above technical solutions, the association relationship determining module includes: a sampling unit, configured to perform a sampling operation on neighbor nodes of the node corresponding to the to-be-detected text, to reduce the number of the neighbor nodes of the node corresponding to the to-be-detected text, where the neighbor nodes are nodes each having a connection edge with the node corresponding to the to-be-detected text;
a determining unit, configured to determine a structure diagram composed of the node corresponding to the to-be-detected text, neighbor nodes obtained through sampling, a node associated with the neighbor nodes obtained through sampling and the connection edges, as the association relationships between the to-be-detected text and the elements and the association relationships between the elements.

On the basis of the above technical solutions, the element includes at least one of an author, a reader, and comment information;
the type of the association relationship includes at least one of: a reading relationship, a releasing relationship, a liking relationship, a commenting relationship, and a forwarding relationship.

On the basis of the above technical solutions, the determining module 810 includes:
a converting unit, configured to adopt different conversion algorithms for attribute information of different categories of the to-be-detected text, to obtain expression vectors of the attribute information of different categories;
an extracting unit, configured to obtain a zero-order feature vector of the node corresponding to the to-be-detected text, through a pooling operation on the expression vectors of the attribute information of different categories; and
a determining unit, configured to determine the zero-order feature vector as the first attribute feature.

On the basis of the above technical solutions, the detecting module 820 includes:
an aggregating unit, configured to aggregate, by combining an attention mechanism, a (K−1)-order feature vector of the node corresponding to the to-be-detected text and (K−1)-order feature vectors of the neighbor nodes of the node corresponding to the to-be-detected text, to obtain a K-order feature vector of the node corresponding to the to-be-detected text;
a predicting unit, configured to predict, based on the K-order feature vector, the detection result of the to-be-detected text to obtain the detection result; where K is a hyperparameter of the network model, which is determined by pre-training the network model.

On the basis of the above technical solutions, the attribute information of different categories of the to-be-detected text includes at least one of: numerical-type attribute information, text-type attribute information, image-type attribute information and audio-type attribute information.

The first attribute feature includes at least one of: a text feature, a picture feature, a soundtrack feature, a number-of-likes feature, a number-of-forwarding feature, a number-of-comments feature, a comment information feature, a number-of-views feature, and an online time feature;
the second attribute feature includes at least one of: a reader portrait, an author portrait and a release time feature.

In the technical solution of the embodiment of the present disclosure, through technical means of determining a first attribute feature of a to-be-detected text and a second attribute feature of elements each having an association relationship with the to-be-detected text; inputting the first attribute feature, the second attribute feature, association relationships between the to-be-detected text and the elements, and association relationships between the elements into a trained network model to obtain a detection result of the to-be-detected text, a purpose of improving the detection precision of a low-quality text is realized.

The text detection apparatus provided by the embodiment of the present disclosure may execute the text detection method provided by any embodiment of the present disclosure, and has function modules and beneficial effects corresponding to the execution of the method.

It is worth noting that the units and modules included in the above apparatus are only divided according to functional logic, but are not limited to the above division, as long as the corresponding functions can be realized. In addition, the specific names of the functional units are only for the convenience of distinguishing from each other, and are not used to limit a protection scope of the embodiments of the present disclosure.

### Embodiment 5

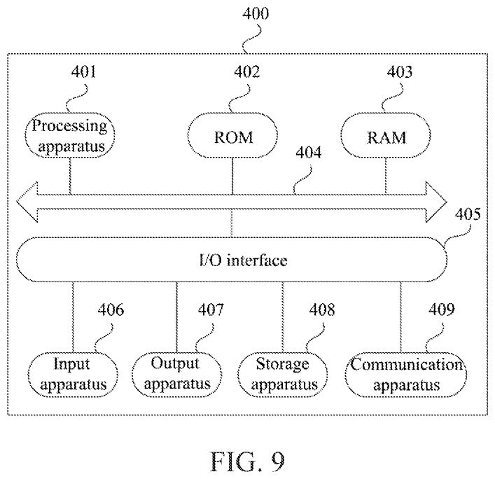

Hereinafter, referring to FIG. 9, a schematic structural diagram of an electronic device (e.g., a terminal device or a server in FIG. 9) 400 suitable for implementing the embodiments of the present disclosure is shown. The terminal device in the embodiments of the present disclosure may include, but are not limited to: a mobile terminal, such as a mobile phone, a notebook computer, a digital broadcast receiver, a PDA (Personal Digital Assistant, personal digital assistant), a PAD (Portable android device, portable android device), a PMP (Portable Media Player, portable media player), an in-vehicle terminal (e.g., an in-vehicle navigation terminal); and a stationary terminal, such as a digital TV, and a desktop computer. The electronic device shown in FIG. 9 is merely an example, and should not impose any restriction on the function and application scope of the embodiments of the present disclosure.

As shown in FIG. 9, the electronic device 400 may include a processing apparatus (for example, a central processing unit, and a graphics processor) 401, which may perform various appropriate actions and processes according to a program stored in a read-only memory (ROM) 402 or a program loaded from a memory apparatus 408 into a random access memory (RAM) 403. In the RAM 403, various programs and data required for operations of the electronic device 400 are also stored. The processing apparatus 401, the ROM 402, and the RAM 403 are connected to each other through a bus 404. An input/output (I/O) interface 405 is also connected to bus 404.

Generally, the following apparatuses may be connected to the I/O interface 405: an input apparatus 406, including for example a touch screen, a touch panel, a keyboard, a mouse, a camera, a microphone, an accelerometer, and a gyroscope; an output apparatus 407, including for example a liquid crystal display (LCD), a speaker, and a vibrator; a storage apparatus 408 including for example a magnetic tape, and a hard disk; and a communication apparatus 409. The communication apparatus 409 may allow the electronic device 400 to perform wireless or wired communication with other devices to exchange data. Although FIG. 9 shows the electronic device with multiple apparatuses, comprehensibly, it is not required to implement or have all the shown apparatuses. It may alternatively be implemented or provided with more or fewer apparatuses.

In particular, according to an embodiment of the present disclosure, the process described above with reference to the flowchart may be implemented as a computer software program. For example, an embodiment of the present disclosure includes a computer program product, which includes a computer program carried on a non-transitory computer readable medium, and the computer program contains program codes for executing the method shown in the flowchart. In such an embodiment, the computer program may be downloaded from a network and installed through the communication apparatus 409, or installed from the storage apparatus 408, or installed from the ROM 402. When the computer program is executed by the processing apparatus 401, the above-mentioned functions defined in the method of the embodiment of the present disclosure are executed. Embodiments of the present disclosure also include a computer program, when the computer program is executed on an electronic device, the above functions defined in the methods of the embodiments of the present disclosure are executed.

The terminal provided by the embodiment of the present disclosure and the text detection methods provided by the above embodiments belong to the same inventive concept. For technical details not described in detail in the embodiment of the present disclosure, reference may be made to the above embodiments, and the embodiment of the present disclosure has the same beneficial effect as the above embodiments.

### Embodiment 6

Embodiments of the present disclosure provide a computer storage medium having a computer program stored thereon, when the program is executed by a processor, the text detection method provided by the foregoing embodiments is implemented.

It should be noted that, the above-mentioned computer readable medium in the present disclosure may be a computer readable signal medium or a computer readable storage medium or any combination of the both. The computer readable storage medium may be, for example, but not limited to, an electrical, magnetic, optical, electromagnetic, infrared, or semiconductor system, apparatus or device, or any combination of the above. More specific examples of the computer readable storage medium may include, but are not limited to: an electrical connection with one or more wires, a portable computer disk, a hard disk, a random access memory (RAM), a read only memory (ROM), an erasable programmable read-only memory (EPROM), or flash memory an optical fiber, a compact disc read-only memory (CD-ROM), an optical storage device, a magnetic storage device, or any suitable combination of the above. In the present disclosure, the computer readable storage medium may be any tangible medium that contains or stores a program, and the program may be used by or in combination with an instruction execution system, apparatus, or device. In the present disclosure, the computer readable signal medium may include a data signal propagated in a baseband or propagated as a part of a carrier wave, and a computer readable program code is carried therein. This propagated data signal may adopt many forms, including but not limited to, an electromagnetic signal, an optical signal, or any suitable combination of the above. The computer readable signal medium may also be any computer readable medium other than the computer readable storage medium, the computer readable signal medium may send, propagate, or transmit the program used by or in combination with the instruction execution system, apparatus, or device. The program codes contained on the computer readable medium may be transmitted by any suitable medium, including but not limited to: a wire, an optical cable, a radio frequency (RF), etc., or any suitable combination of the above.

In some embodiments, a client and a server may use any currently known or future developed network protocol such as hypertext transfer protocol (HTTP) to communicate, and may interconnect with digital data communication (e.g., a communication network) in any form or medium. Examples of communication networks include a local area network (LAN), a wide area network (WAN), an Internet (e.g., an Internet), and a peer-to-peer network (e.g., ad hoc peer-to-peer networks), and any currently known or future developed networks.

The above computer readable medium may be included in the above electronic device; or may exist alone without being assembled into the electronic device.

The above computer readable medium carries one or more programs, and when the above one or more programs are executed by the electronic device, cause the electronic device to:
determine a first attribute feature of a to-be-detected text and a second attribute feature of elements each having an association relationship with the to-be-detected text;
input the first attribute feature, the second attribute feature, association relationships between the to-be-detected text and the elements, and association relationships between the elements into a trained network model to obtain a detection result of the to-be-detected text.

The computer program codes used to perform operations of the present disclosure may be written in one or more programming languages or a combination thereof. The above-mentioned programming languages include an object-oriented programming language, such as Java, Smalltalk, and C++, and also include a conventional procedural programming language, such as “C” language or similar programming language. The program codes may be executed entirely on a computer of a user, partly on a computer of a user, executed as an independent software package, partly executed on a computer of a user and partly executed on a remote computer, or entirely executed on a remote computer or server. In a case where a remote computer is involved, the remote computer may be connected to the computer of the user through any kind of network, including a local area network (LAN) or a wide area network (WAN); alternatively, it may be connected to an external computer (for example, connected via the Internet through an Internet service provider).

The flowcharts and block diagrams in the accompanying drawings illustrate possible implementation architecture, functions, and operations of the system, method, and computer program product according to the embodiments of the present disclosure. In this point, each block in the flowchart or block diagram may represent a module, a program segment, or a part of code, and the module, the program segment, or the part of code contains one or more executable instructions for implementing a designated logical function. It should also be noted that, in some alternative implementations, the functions marked in the blocks may also occur in a different order from the order marked in the drawings. For example, two blocks shown one after another may actually be executed substantially in parallel, or sometimes may be executed in a reverse order, which depends on the functions involved. It should also be noted that, each block in the block diagram and/or flowchart, and a combination of the blocks in the block diagram and/or flowchart, may be implemented by a dedicated hardware-based system that performs designated functions or operations, or may be implemented by a combination of dedicated hardware and computer instructions.

The units involved in the embodiments of the present disclosure may be implemented in software or hardware. Where a name of a unit does not constitute a limitation on the unit itself in a certain case, for example, an editable content display unit may also be described as an “editing unit”.

The functions described above may be performed at least in part by one or more hardware logic components. For example, non-restrictively, exemplary types of hardware logic components that may be used include: a field programmable gate array (FPGA), an application specific integrated circuit (ASIC), an application specific standard product (ASSP), a system on chip (SOC), a complex programmable logic device (CPLD), etc.

According to one or more embodiments of the present disclosure, [Example 1] provides a text detection method, the method includes:
determining a first attribute feature of a to-be-detected text and a second attribute feature of elements each having an association relationship with the to-be-detected text;
inputting the first attribute feature, the second attribute feature, association relationships between the to-be-detected text and the elements, and association relationships between the elements into a trained network model to obtain a detection result of the to-be-detected text.

According to one or more embodiments of the present disclosure, [Example 2] provides a text detection method on the basis of Example 1. In an implementation, before the inputting the first attribute feature, the second attribute feature, association relationships between the to-be-detected text and the elements, and association relationships between the elements into a trained network model, it further includes:
determining the to-be-detected text and the elements as nodes respectively;
generating, according to types of the association relationships between the to-be-detected text and the elements, connection edges between a node corresponding to the to-be-detected text and nodes corresponding to the elements;
generating, according to types of the association relationships between the elements, connection edges between the nodes corresponding to the elements; and
determining, according to a structure diagram composed of the nodes and the connection edges, the association relationships between the to-be-detected text and the elements and the association relationships between the elements.

According to one or more embodiments of the present disclosure, [Example 3] provides a text detection method on the basis of Example 2. In an implementation, the determining, according to a structure diagram composed of the nodes and the connection edges, the association relationships between the to-be-detected text and the elements and the association relationships between the elements, includes:
performing a sampling operation on neighbor nodes of the node corresponding to the to-be-detected text, where the neighbor nodes are nodes each having a connection edge with the node corresponding to the to-be-detected text; and
determining a structure diagram composed of the node corresponding to the to-be-detected text, neighbor nodes obtained through sampling, a node associated with the neighbor nodes obtained through sampling and the connection edges, as the association relationships between the to-be-detected text and the elements and the association relationships between the elements.

According to one or more embodiments of the present disclosure, [Example 4] provides a text detection method on the basis of Example 2. In an implementation, the element includes at least one of: an author, a reader, and comment information;
the type of the association relationship includes at least one of: a reading relationship, a releasing relationship, a liking relationship, a commenting relationship, and a forwarding relationship.

According to one or more embodiments of the present disclosure, [Example 5] provides a text detection method on the basis of Example 4. In an implementation, the determining a first attribute feature of the to-be-detected text, includes:
adopting different conversion algorithms for attribute information of different categories of the to-be-detected text, to obtain expression vectors of the attribute information of different categories;
obtaining a zero-order feature vector of the node corresponding to the to-be-detected text, through a pooling operation on the expression vectors of the attribute information of different categories; and
determining the zero-order feature vector as the first attribute feature.

According to one or more embodiments of the present disclosure, [Example 6] provides a text detection method on the basis of Example 4. In an implementation, the inputting the first attribute feature, the second attribute feature, association relationships between the to-be-detected text and the elements, and association relationships between the elements into a trained network model to obtain a detection result of the to-be-detected text, includes:
aggregating, by combining an attention mechanism, a (K−1)-order feature vector of the node corresponding to the to-be-detected text and (K−1)-order feature vectors of the neighbor nodes of the node corresponding to the to-be-detected text, to obtain a K-order feature vector of the node corresponding to the to-be-detected text; and
predict, based on the K-order feature vector, the detection result of the to-be-detected text to obtain the detection result;
where K is a hyperparameter of the network model, which is determined by pre-training the network model.

According to one or more embodiments of the present disclosure, [Example 7] provides a text detection method on the basis of Example 1. In an implementation, the attribute information of different categories of the to-be-detected text includes at least one of: numerical-type attribute information, text-type attribute information, image-type attribute information and audio-type attribute information.

According to one or more embodiments of the present disclosure, [Example 8] provides a text detection method on the basis of Example 1. In an implementation, the first attribute feature includes at least one of: a text feature, a picture feature, a soundtrack feature, a number-of-likes feature, a number-of-forwarding feature, a number-of-comments feature, a comment information feature, a number-of-views feature, and an online time feature;
the second attribute feature includes at least one of: a reader portrait, an author portrait and a release time feature.

According to one or more embodiments of the present disclosure, [Example 9] provides a text detection apparatus, the apparatus includes: a determining module, configured to determine a first attribute feature of a to-be-detected text and a second attribute feature of elements each having an association relationship with the to-be-detected text;
a detecting module, configured to input the first attribute feature, the second attribute feature, association relationships between the to-be-detected text and the elements, and association relationships between the elements into a trained network model to obtain a detection result of the to-be-detected text.

According to one or more embodiments of the present disclosure, [Example 10] provides an electronic device, the electronic device includes:
one or more processors;
a storage apparatus, configured to store one or more programs,
the one or more programs, when being executed by the one or more processors, cause the one or more processors to implement a text detection method as follows:
determining a first attribute feature of a to-be-detected text and a second attribute feature of elements each having an association relationship with the to-be-detected text;
inputting the first attribute feature, the second attribute feature, association relationships between the to-be-detected text and the elements, and association relationships between the elements into a trained network model to obtain a detection result of the to-be-detected text.

According to one or more embodiments of the present disclosure, [Example 11] provides a storage medium, including computer executable instructions, the computer-executable instructions, when being executed by a computer processor, cause a text detection method as follows to be implemented:
determining a first attribute feature of a to-be-detected text and a second attribute feature of elements each having an association relationship with the to-be-detected text; and
inputting the first attribute feature, the second attribute feature, association relationships between the to-be-detected text and the elements, and association relationships between the elements into a trained network model to obtain a detection result of the to-be-detected text.

The above description is only preferred embodiments of the present disclosure and an illustration of the applied technical principles. Those skilled in the art should understand that, the disclosure scope involved in the present disclosure is not limited to the technical solutions formed by the specific combination of the above technical features, but also covers other technical solutions formed by the arbitrary combination of the above technical features or their equivalent features without departing from the above disclosure concept, for example, a technical solution formed by replacing a above-mentioned feature with a technical feature with similar functions disclosed (but not limited to) in the present disclosure.

In addition, although the individual operations are described in a specific order, this should not be understood as requiring these operations to be performed in the specific order or in a sequential order shown. Under certain circumstances, multitasking and parallel processing may be advantageous. Similarly, although several specific implementation details are included in the above discussion, these should not be interpreted as limiting the scope of the present disclosure. Certain features described in the context of separate embodiments may also be implemented in combination in a single embodiment. Conversely, various features described in the context of a single embodiment may also be implemented in multiple embodiments individually or in any suitable sub combination.

Although the subject matters have been described in languages specific to structural features and/or method logical actions, it should be understood that the subject matters defined in the appended claims are not limited to the specific features or actions described above. On the contrary, the specific features and actions described above are only exemplary forms for implementing the claims.

What is claimed is:

1-13. (canceled)

14. A text detection method, comprising:
determining a first attribute feature of a to-be-detected text and a second attribute feature of elements each having an association relationship with the to-be-detected text; and
inputting the first attribute feature, the second attribute feature, association relationships between the to-be-detected text and the elements, and association relationships between the elements into a trained network model to obtain a detection result of the to-be-detected text.

15. The method according to claim 14, wherein before the inputting the first attribute feature, the second attribute feature, association relationships between the to-be-detected text and the elements, and an association relationship between the elements into a trained network model, the method further comprises:
determining the to-be-detected text and the elements as nodes respectively;
generating, according to types of the association relationships between the to-be-detected text and the elements, connection edges between a node corresponding to the to-be-detected text and nodes corresponding to the elements;
generating, according to types of the association relationships between the elements, connection edges between the nodes corresponding to the elements; and
determining, according to a structure diagram composed of the nodes and the connection edges, the association relationships between the to-be-detected text and the elements, and the association relationships between the elements.

16. The method according to claim 15, wherein the determining, according to a structure diagram composed of the nodes and the connection edges, the association relationships between the to-be-detected text and the elements and the association relationships between the elements comprises:
performing a sampling operation on neighbor nodes of the node corresponding to the to-be-detected text, wherein the neighbor nodes are nodes each having a connection edge with the node corresponding to the to-be-detected text; and
determining a structure diagram composed of the node corresponding to the to-be-detected text, neighbor nodes obtained through sampling, a node associated with the neighbor nodes obtained through sampling and the connection edges, as the association relationships between the to-be-detected text and the elements and the association relationships between the elements.

17. The method according to claim 15, wherein the determining a first attribute feature of the to-be-detected text comprises:
adopting different conversion algorithms for attribute information of different categories of the to-be-detected text, to obtain expression vectors of the attribute information of different categories;
obtaining a zero-order feature vector of the node corresponding to the to-be-detected text, through a pooling operation on the expression vectors of the attribute information of different categories; and
determining the zero-order feature vector as the first attribute feature.

18. The method according to claim 17, wherein the inputting the first attribute feature, the second attribute feature, association relationships between the to-be-detected text and the elements, and association relationships between the elements into a trained network model to obtain a detection result of the to-be-detected text comprises:
aggregating, by combining an attention mechanism, a (K−1)-order feature vector of the node corresponding to the to-be-detected text and (K−1)-order feature vectors of the neighbor nodes of the node corresponding to the to-be-detected text, to obtain a K-order feature vector of the node corresponding to the to-be-detected text; and
predicting, based on the K-order feature vector, the detection result of the to-be-detected text to obtain the detection result;
wherein K is a hyperparameter of the network model, and is determined by pre-training the network model.

19. The method according to claim 17, wherein the attribute information of different categories of the to-be-detected text comprises at least one of: numerical-type attribute information, text-type attribute information, image-type attribute information and audio-type attribute information.

20. The method according to claim 14, wherein the element comprises at least one of: an author, a reader, and comment information;
the type of the association relationship comprises at least one of: a reading relationship, a releasing relationship, a liking relationship, a commenting relationship, and a forwarding relationship.

21. The method according to claim 14, wherein the first attribute feature comprises at least one of: a text feature, a picture feature, a soundtrack feature, a number-of-likes feature, a number-of-forwarding feature, a number-of-comments feature, a comment information feature, a number-of-views feature, and an online time feature;
the second attribute feature comprises at least one of: a reader portrait, an author portrait and a release time feature.

22. A text detection apparatus, comprising:
one or more processors;
a storage apparatus, configured to store one or more programs, the one or more programs, when being executed by the one or more processors, cause the one or more processors to:
determine a first attribute feature of a to-be-detected text and a second attribute feature of elements each having an association relationship with the to-be-detected text;
input the first attribute feature, the second attribute feature, association relationships between the to-be-detected text and the elements, and association relationships between the elements into a trained network model to obtain a detection result of the to-be-detected text.

23. The apparatus according to claim 22, wherein the one or more processors are further configured to:
determine the to-be-detected text and the elements as nodes respectively;
generate, according to types of the association relationships between the to-be-detected text and the elements, connection edges between a node corresponding to the to-be-detected text and nodes corresponding to the elements;
generate, according to types of the association relationships between the elements, connection edges between the nodes corresponding to the elements; and
determine, according to a structure diagram composed of the nodes and the connection edges, the association relationships between the to-be-detected text and the elements, and the association relationships between the elements.

24. The apparatus according to claim 23, wherein the one or more processors are further configured to:
perform a sampling operation on neighbor nodes of the node corresponding to the to-be-detected text, wherein the neighbor nodes are nodes each having a connection edge with the node corresponding to the to-be-detected text; and
determine a structure diagram composed of the node corresponding to the to-be-detected text, neighbor nodes obtained through sampling, a node associated with the neighbor nodes obtained through sampling and the connection edges, as the association relationships between the to-be-detected text and the elements and the association relationships between the elements.

25. The apparatus according to claim 23, wherein the one or more processors are further configured to:
adopt different conversion algorithms for attribute information of different categories of the to-be-detected text, to obtain expression vectors of the attribute information of different categories;
obtain a zero-order feature vector of the node corresponding to the to-be-detected text, through a pooling operation on the expression vectors of the attribute information of different categories; and
determine the zero-order feature vector as the first attribute feature.

26. The apparatus according to claim 25, wherein the one or more processors are further configured to:
aggregate, by combining an attention mechanism, a (K−1)-order feature vector of the node corresponding to the to-be-detected text and (K−1)-order feature vectors of the neighbor nodes of the node corresponding to the to-be-detected text, to obtain a K-order feature vector of the node corresponding to the to-be-detected text; and
predict, based on the K-order feature vector, the detection result of the to-be-detected text to obtain the detection result;
wherein K is a hyperparameter of the network model, and is determined by pre-training the network model.

27. The apparatus according to claim 25, wherein the attribute information of different categories of the to-be-detected text comprises at least one of: numerical-type attribute information, text-type attribute information, image-type attribute information and audio-type attribute information.

28. The apparatus according to claim 22, wherein the element comprises at least one of: an author, a reader, and comment information;
the type of the association relationship comprises at least one of: a reading relationship, a releasing relationship, a liking relationship, a commenting relationship, and a forwarding relationship.

29. The apparatus according to claim 22, wherein the first attribute feature comprises at least one of: a text feature, a picture feature, a soundtrack feature, a number-of-likes feature, a number-of-forwarding feature, a number-of-comments feature, a comment information feature, a number-of-views feature, and an online time feature;
the second attribute feature comprises at least one of: a reader portrait, an author portrait and a release time feature.

30. A non-transitory storage medium, comprising computer executable instructions, wherein the computer executable instructions, when being executed by a computer processor, cause the following steps to be implemented:
determining a first attribute feature of a to-be-detected text and a second attribute feature of elements each having an association relationship with the to-be-detected text; and
inputting the first attribute feature, the second attribute feature, association relationships between the to-be-detected text and the elements, and association relationships between the elements into a trained network model to obtain a detection result of the to-be-detected text.

31. The non-transitory storage medium according to claim 30, wherein the computer executable instructions, when being executed by the computer processor, cause the following steps to be implemented:
determining the to-be-detected text and the elements as nodes respectively;
generating, according to types of the association relationships between the to-be-detected text and the elements, connection edges between a node corresponding to the to-be-detected text and nodes corresponding to the elements;
generating, according to types of the association relationships between the elements, connection edges between the nodes corresponding to the elements; and
determining, according to a structure diagram composed of the nodes and the connection edges, the association relationships between the to-be-detected text and the elements, and the association relationships between the elements.

32. The non-transitory storage medium according to claim 31, wherein the computer executable instructions, when being executed by the computer processor, cause the following steps to be implemented:
performing a sampling operation on neighbor nodes of the node corresponding to the to-be-detected text, wherein the neighbor nodes are nodes each having a connection edge with the node corresponding to the to-be-detected text; and
determining a structure diagram composed of the node corresponding to the to-be-detected text, neighbor nodes obtained through sampling, a node associated with the neighbor nodes obtained through sampling and the connection edges, as the association relationships between the to-be-detected text and the elements and the association relationships between the elements.

33. The non-transitory storage medium according to claim 31, wherein the computer executable instructions, when being executed by the computer processor, cause the following steps to be implemented:
adopting different conversion algorithms for attribute information of different categories of the to-be-detected text, to obtain expression vectors of the attribute information of different categories;
obtaining a zero-order feature vector of the node corresponding to the to-be-detected text, through a pooling operation on the expression vectors of the attribute information of different categories; and
determining the zero-order feature vector as the first attribute feature.
